(19) United States
(12) Patent Application Publication
(10) Pub. No.: US 2010/0166382 A1
(43) Pub. Date: Jul. 1, 2010

(54) VIDEO AND AUDIO REPRODUCTION SYSTEM, DISTRIBUTION DEVICE, AND SYNCHRONIZATION ADJUSTMENT METHOD

(75) Inventor: Masahiro Ogawa, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/630,032

(22) Filed: Dec. 3, 2009

(30) Foreign Application Priority Data
Dec. 25, 2008 (JP) 2008-330437

(51) Int. Cl. H04N 5/91

(52) U.S. Cl. 386/66; 386/E05.003

(57) ABSTRACT

A distribution device includes a video data distributing section which distributes video reproducing video data to an external video display device, and an audio data distributing section for distributing audio reproducing audio data to an external audio output device. The audio data distributing section includes an audio distribution delay unit for delaying the distribution of the audio data. The distribution device is configured to be able to distribute the audio data of a determination audio and the video data of a determination video. The determination video is a video with which a viewer can visually judge a timing the determination audio is to be output from the audio output device. The determination audio and the determination video are contained in synchronization adjustment test content.

### CROSS REFERENCE TO RELATED APPLICATIONS

This application is based upon and claims the benefit of priority from the prior Japanese Patent Application No. 2008-330437 filed on Dec. 25, 2008 in Japan, the entire contents of which are incorporated herein by reference.

### BACKGROUND OF THE INVENTION

1. Field of the Invention

The present invention relates to a video and audio reproduction system, distribution device, and synchronization adjustment method.

2. Related Art

Conventionally, in digital broadcast and IP (Internet Protocol) broadcast, the reception signal is demodulated by a tuner incorporated in an STB (Set Top Box) or a digital television to obtain a TS (Transport Stream). The TS is assigned a PID (Packet ID) corresponding to the type of data such as video, audio, and EPG (Electronic Program Guide). The TS is decoded in the digital television, and the decoded signal is output to either a display or a built-in speaker according to the type of data based on the PID. Generally, longer time is required for the display process of the video data than for the output process of the audio data. Thus, the video and the audio are synchronized in the digital television so as not to create a time difference between the video to be displayed and the audio to be output.

Demands of the viewer on image quality and sound quality are increasing in recent years, and higher image quality and higher sound quality are also demanded on the digital television. In particular, in regards to sound quality, the built-in speaker of the digital television has inferior sound quality compared to commercially available high class amplifier and speaker. It is difficult to respond to a surround system of 5.1 ch and 7.1 ch with only the digital television. Due to such reasons, a digital audio system is connected to the exterior of the digital television. Conventionally, in the digital audio system used by being connected to the digital television, the ES (Elementary Stream) from the digital television or the PCM (Pulse Code Modulation) after decoding is received by the audio amplifier, where the ES is decoded and output to the speaker.

A home server system (video and audio reproduction system) capable of achieving higher image quality and higher sound quality is proposed. The home server system receives, stores, and decodes digital content of the digital broadcast, the IP broadcast and the like with the home server, where the video is displayed by a display (e.g., digital television) and the audio is output from the speaker of the audio system.

In such home server system, however, the display for display processing the video data and the audio system for output processing the audio data are separate devices, and each device performs an independent process. Thus, even if the video data and the audio data are synchronized and distributed from the server, the video displayed on the display and the audio output from the audio system cannot be synchronized, which gives an unnatural feeling to the viewer.

In a system of connecting a plurality of AV devices through a network, and displaying the video with the television and the like and outputting the audio with the audio system, a technique of synchronizing the video and the audio is known (see Japanese Patent Application Laid-Open No. 2008-136027). However, in such technique, mutual communication between devices and a special audio system are required to synchronize the video and the audio under a situation where the delay time in the network changes by the minute. Furthermore, output of audio and the like takes time as the communication between devices is in great amount.

### SUMMARY OF THE INVENTION

In accordance with one embodiment of the present invention, there is provided a distribution device including: a video data distributing section which distributes video reproducing video data to an external video display device; and an audio data distributing section which distributes audio reproducing audio data to an external audio output device, wherein the audio data distributing section includes an audio distribution delay unit which delays the distribution of the audio data, the distribution device is configured to be able to distribute the audio data of a determination audio and the video data of a determination video, the determination video is a video with which a viewer can visually judge a timing the determination audio is to be output from the audio output device, and the determination audio and the determination video are contained in synchronization adjustment test content.

Moreover, in accordance with another embodiment of the present invention, there is provided a video and audio reproduction system including: a distribution device which includes a video data distributing section and an audio data distributing section, the video data distributing section distributing video reproducing video data, the audio data distributing section distributing audio reproducing audio data; a video display device which processes the distributed video data and displays the video data as a video; and an audio output device which processes the distributed audio data and outputs the audio data as an audio, wherein the distribution device is configured to be able to distribute the audio data of a determination audio and the video data of a determination video, the determination video is a video with which a viewer can visually judge a timing the determination audio is to be output from the audio output device, the determination audio and the determination video are contained in synchronization adjustment test content, and at least either the distribution device or the audio output device is configured to delay the output of the audio from the audio output device so that the determination audio is output at the timing in the determination video.

In addition, in accordance with a further embodiment of the present invention, there is provided a synchronization adjustment method using a video and audio reproduction system including: a distribution device which includes a video data distributing section and an audio data distributing section, the video data distributing section distributing video reproducing video data, the audio data distributing section distributing audio reproducing audio data; a video display device which processes the distributed video data and displays the video data as a video; and an audio output device which processes the distributed audio data and outputs the audio data as an audio, the method including: distributing the audio data of a determination audio and the video data of a determination video by the distribution device, the determination video being a video with which a viewer can visually judge a timing the determination audio is to be output from the audio output device, the determination audio and the determination video being contained in synchronization adjustment test content; and delaying the output of the audio from the audio output device by an audio delay time by at least either the distribution device or the audio output device so that the determination audio is output at the timing in the determination video.

### BRIEF DESCRIPTION OF THE DRAWINGS

FIG. 1 is an overall configuration view of a video and audio reproduction system according to a first embodiment of the present invention;

FIG. 2 is a block diagram of a server according to the first embodiment of the present invention;

FIG. 3 is an explanatory view of a test content according to the first embodiment of the present invention;

FIG. 4 is a schematic view showing a data format of the test content according to the first embodiment of the present invention;

FIG. 4A is a flowchart showing a processing flow of the delay process according to the first embodiment of the present invention;

FIG. 4B is a view showing a relationship between the STC, the PTS, and the delay time according to the first embodiment of the present invention;

FIG. 5 is an overall configuration view of a video and audio reproduction system according to a second embodiment of the present invention;

FIG. 5A is a block diagram of a server according to the second embodiment of the present invention;

FIG. 6 is an explanatory view of a calculation method of an audio delay time according to the second embodiment of the present invention; and

FIG. 7 is an explanatory view of a calculation method of a video delay time according to the second embodiment of the present invention.

### DETAILED DESCRIPTION OF THE INVENTION

The embodiments of the present invention will be described below with reference to the drawings. Such embodiments are not intended to limit the present invention.

In the following embodiments, one example of receiving the digital broadcast will be described.

### First Embodiment

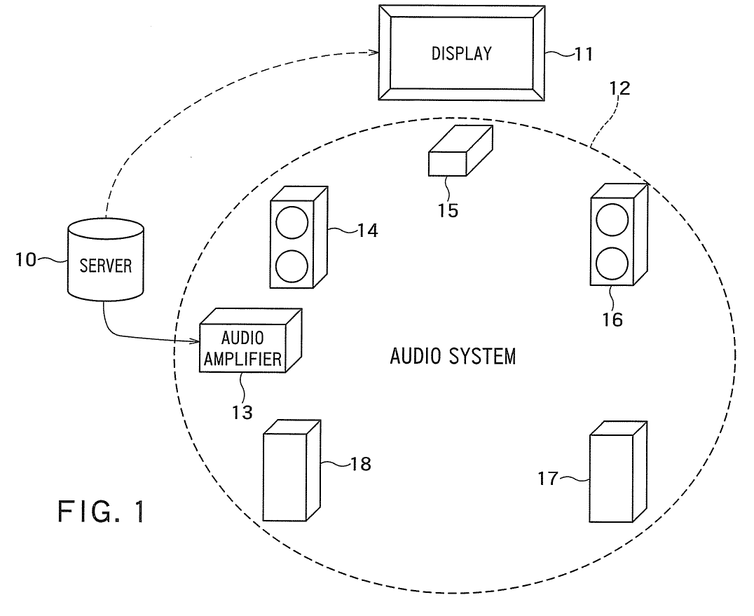

A first embodiment of the present invention will be described with reference to FIGS. 1 to 4. The present embodiment reproduces a test content containing a determination video with which the timing a determination audio is to be output can be visually judged, and adjusts the delay time of the video data and the audio data based on the gap in timing of the display of the determination video and the output of the determination audio.

First, the configuration of a video and audio reproduction system according to the present embodiment will be described. As shown in FIG. 1, the video and audio reproduction system includes a server 10 (distribution device), a display 11 (video display device), and an audio system 12 (audio output device).

The server 10 receives, demodulates, and stores the digital content of the digital broadcast, the IP broadcast and the like. The server 10 also decodes the stored data, distributes the decoded video reproducing video data to the display 11 and distributes the decoded audio reproducing audio data to the audio system 12.

The display 11 processes the distributed video data and displays the same as a video.

The audio system 12 processes the distributed audio data with an audio amplifier 13, and outputs the same as audio from speakers 14 to 18.

The display 11 is assumed to be installed by being hanged on a wall, and the like. Here, the server 10 and the display 11 are assumed to be wirelessly connected. The server 10 and the audio amplifier 13 of the audio system 12 are wire connected.

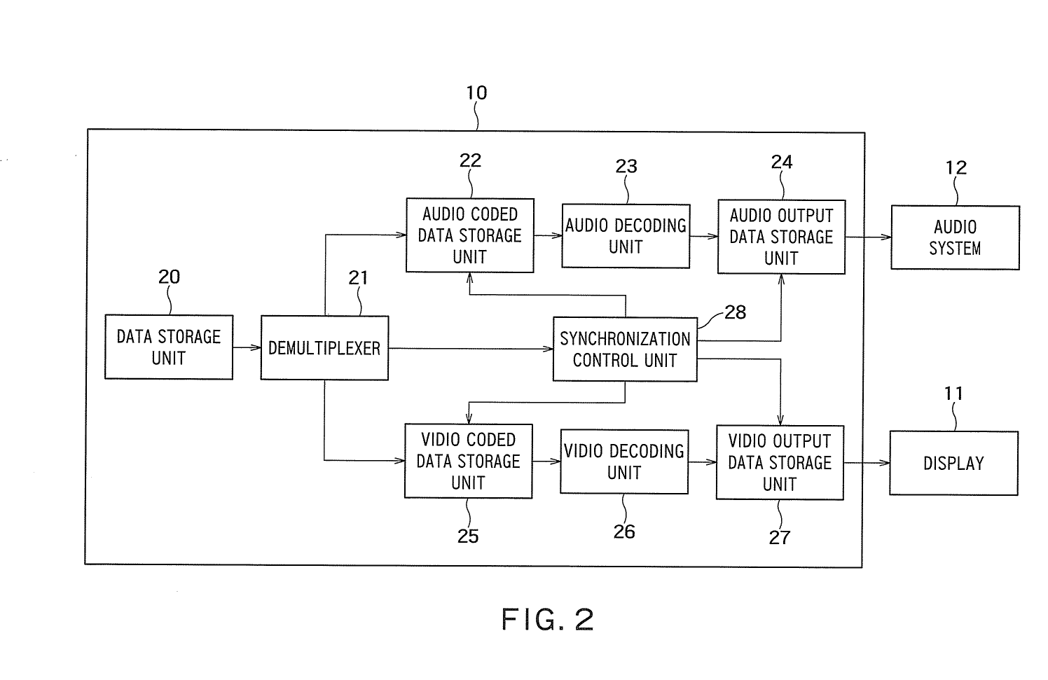

The server 10 will be more specifically described with reference to FIG. 2. FIG. 2 is a block diagram of the server 10.

First, the data (TS: Transport Stream) stored in a data storage unit 20 is divided to audio coded data and video coded data by a demultiplexer 21. The audio coded data is stored in an audio coded data storage unit 22, and the video coded data is stored in a video coded data storage unit 25.

An audio decoding unit 23 decodes the audio coded data, and a video decoding unit 26 decodes the video coded data. The decoded audio data is stored in an audio output data storage unit 24, and the decoded video data is stored in a video output data storage unit 27. The video coded data storage unit 25, the video decoding unit 26, and the video output data storage unit 27 function as a video data distributing section. The audio coded data storage unit 22, the audio decoding unit 23, and the audio output data storage unit 24 function as an audio data distributing section.

A synchronization control unit 28 controls the audio output data storage unit 24 and the video output data storage unit 27 based on time information (PTS: Presentation Time Stamp) added to the audio coded data and the video coded data to control the timing the audio data and the video data are output. As a result, the audio data and the video data are distributed to the audio system 12 and the display 11 while maintaining synchronization.

The synchronization control unit 28 can also set a delay time to the audio output data storage unit 24, the video output data storage unit 27, the audio coded data storage unit 22, and the video coded data storage unit 25.

The control of the audio output data storage unit 24 and the video output data storage unit 27 is carried out by delaying the output of the data by the delay time.

The control of the audio coded data storage unit 22 and the video coded data storage unit 25 is similarly carried out by delaying the output of the data by the delay time. To prevent the audio and the video from being interrupted when data in the audio output data storage unit 24 and the video output data storage unit 27 that can be output are not present, or to reduce the volume of the audio output data storage unit 24 and the video output data storage unit 27 as much as possible, the control may be carried out by the data occupying amount of the audio output data storage unit 24 and the video output data storage unit 27. That is, control may be carried out so as to start decoding when the remaining data of the audio output data storage unit 24 and the video output data storage unit 27 becomes smaller than a predetermined lower limit threshold value and to stop decoding when the remaining data becomes greater than a predetermined upper limit threshold, value.

In this manner, the audio coded data storage unit 22 and the audio output data storage unit 24 (audio distribution delay unit) can delay the distribution of the audio data to the audio system 12. The video coded data storage unit 25 and the video output data storage unit 27 (video distribution delay unit) can delay the distribution of the video data to the display 11.

Whether to set the delay time in the audio coded data storage unit 22 and the video coded data storage unit 25 may be switched in units of system by the length of the necessary delay time and the capacity of the audio output data storage unit 24 and the video output data storage unit 27.

A method of synchronization adjustment of the video content and the audio content will now be described. The synchronization adjustment is performed after setting the installing positions of the display 11 and the audio system 12. In the audio system 12, a position where the viewer listens to the audio is set as a listening point in advance, and the delay etc. of the audio from each speaker 14 to 18 to the viewer are adjusted.

The synchronization adjustment is carried out by distributing a synchronization adjustment test content prepared in advance from the server 10 to the display 11 and the audio system 12 and reproducing the content. The test content may be stored in a storage device arranged in the server 10, may be read out from a recording medium, or may be contained in a reception signal such as the digital broadcast.

The test content will be described below. The video content of the test content contains the determination video with which the timing the determination audio is to be output from the speakers 14 to 18 can be visually judged so that whether or not the video content is synchronized with the audio content can be easily determined.

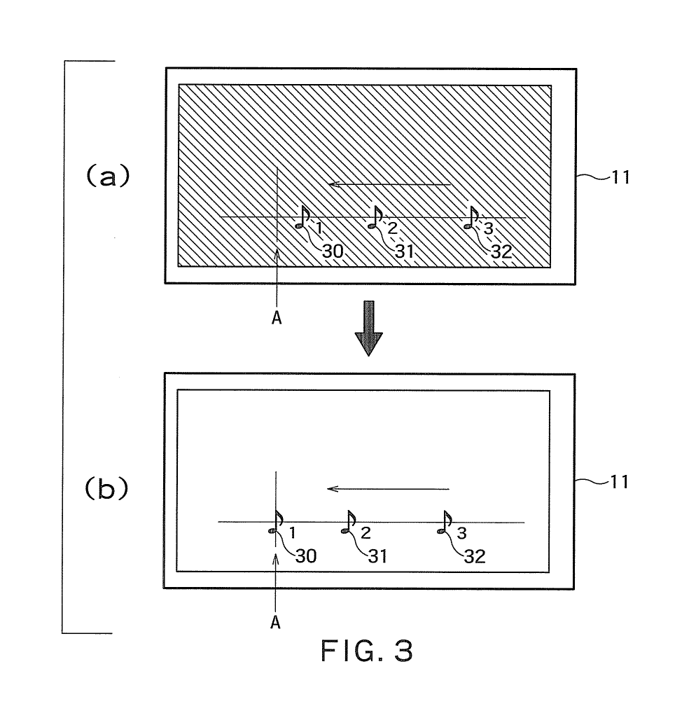

For instance, as shown in FIG. 3, assume a video content containing the determination video where musical notes (symbols) 30 to 32 flow from the right to the left of a screen of the display 11, and the timing the determination audio is to be output is indicated every time each musical note 30 to 32 reaches point A. That is, the test content allows the viewer to hear the determination audio for every timing each musical note 30 to 32 reaches point A if the determination video is synchronized with the determination audio. The video content may have brightness change given to the determination video at the timing the determination audio is to be output.

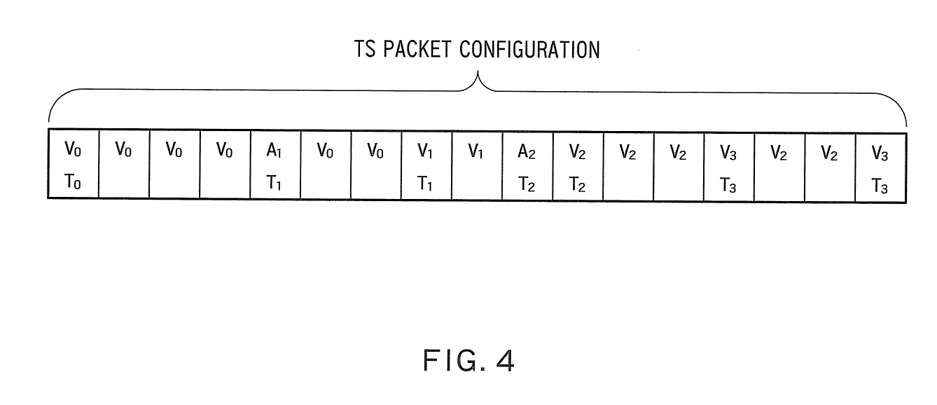

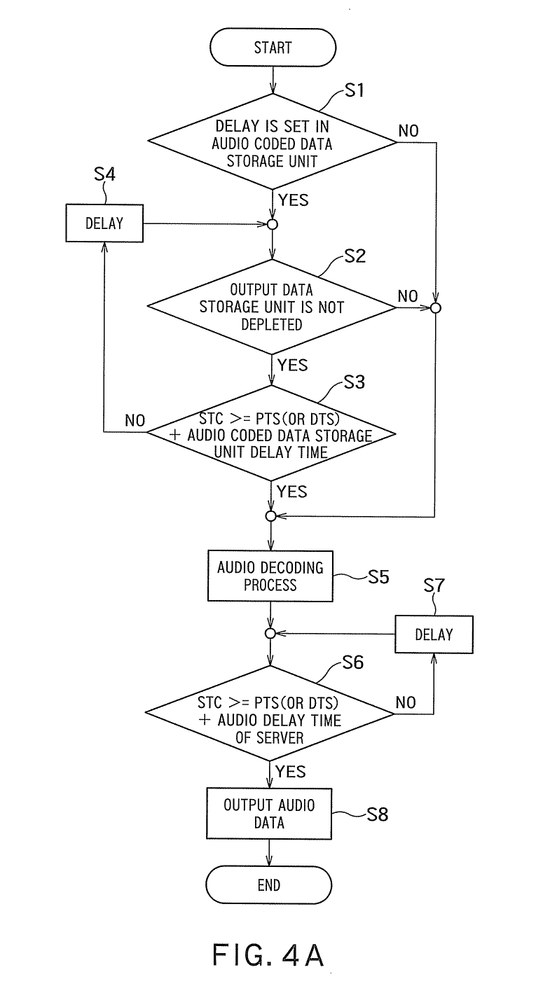

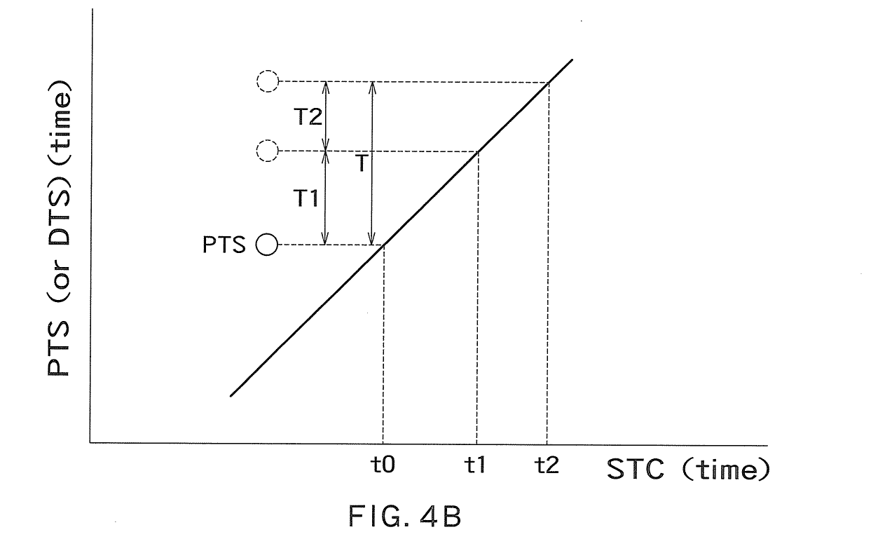

The data format of the test content is a TS packet configuration as shown in FIG. 4 assuming the reception of the digital broadcast. In the figure, Vn represents the TS packet (n^{th} picture) of the video content. An represents the TS packet (n^{th} frame) of the audio content. Same time information (e.g., T1) such as PTS is embedded in the TS packet (e.g., V1) in the picture of the determination video at the timing the determination audio is to be output and the TS packet (e.g., A1) in the frame of the relevant determination audio.

The server 10 decodes the video coded data of the video content and the audio coded data of the audio content contained in the test content. The decoded video data and the audio data are then distributed to the display 11 and the audio system 12 at a timing complying with the PTS. That is, the video data and the audio data having the same PTS are simultaneously distributed.

The viewer sets the delay time to the server 10 to synchronize the determination video with the determination audio so as to hear the determination audio at a timing the musical note 30 reaches point A while looking at the display 11. For instance, if the determination audio is heard before the musical note 30 reaches point A, the viewer sets the delay time of the audio long. If the determination audio is heard after the musical note 30 reached point A, the viewer sets the delay time of the video long. The determination video and the determination audio reaching the viewer at the listening point thus can be synchronized by repeating such adjustment. As a result, the video and the audio can be synchronized even when receiving the digital broadcast and the like, so that the viewer does not feel unnatural.

A case of delaying the audio data will be described, by way of example, for the delay process in the server 10 with reference to FIG. 4A. FIG. 4A is a flowchart showing a processing flow of the delay process according to the first embodiment of the present invention.

As a prerequisite, assume a state in which the time (audio delay time) of delaying the audio output from the server 10 is already obtained and the STC (System Time Clock) (reference time) is restored from the PCR (Packet Clock Reference) contained in the TS.

First, if the delay time in the audio coded data storage unit 22 is not set (step S1: No), the audio decoding unit 23 sequentially performs the decoding process (step S5) as soon as the decodable data is stored in the audio coded data storage unit 22.

If the delay time in the audio coded data storage unit 22 is set (step S1: Yes), whether or not the audio data output from the audio output data storage unit 24 is not depleted is determined (step S2). If the audio data is about to be depleted (step S2: No), the audio decoding process (step S5) is promptly performed without delay. If sufficient data exists in the audio output data storage unit 24 (step S2: Yes), the process of the audio decoding unit 23 is delayed until the STC satisfies equation (1) (step S3: No, step S4).

STC>=PTS (or DTS)+audio coded data storage unit delay time (1)

When the STC satisfies equation (1) (step S3: Yes), the audio decoding unit 23 performs the audio decoding process (step S5).

After the audio decoding process is performed, the start of output of the audio data is delayed until the STC satisfies equation (2) in the audio output data storage unit 24 (step 56: No, step S7).

STC>=PTS (or DTS)+audio delay time (2)

When the STC satisfies equation (2) (step S6: Yes), the audio output data storage unit 24 outputs the audio data (step S8).

The reason for setting the output start time of the audio data from the audio output data storage unit 24 to PTS+audio delay time will now be described with reference to FIG. 4B. FIG. 4B is a view showing a relationship between the STC, the PTS, and the delay time according to the first embodiment of the present invention.

In the figure, the audio delay time is T, the audio coded data storage unit delay time is T1, and the time to delay in the audio output data storage unit is T2. The output time (without delay) based on the PTS is t0, the decoding process start time (with delay of audio coded data storage unit) is t1, and the output time (with delay) in view of the audio delay time is t2.

The time the data starts to be stored in the audio output data storage unit 24 is already delayed by the audio coded data storage unit delay time T1 (+decoding process time) with respect to the time t0 of the STC (time t1+decoding process time). Thus, in the audio output data storage unit 24, the output of the audio data is delayed (time t2) by the audio delay time T expected for the server 10 by delaying until satisfying equation (2).

The audio coded data storage unit delay time is obtained from the capacity of the audio output data storage unit 24, and the like. For instance, if the audio output data storage unit 24 can store the audio data worth one second, the audio coded data storage unit delay time can be obtained with equation (3).

Audio coded data storage unit delay time=audio delay time−1 sec (3)

When controlling the delay time only with the occupying amount of the audio output data storage unit 24, an accurate delay time does not need to be set in the audio coded data storage unit 22.

A case of delaying the audio data has been described above, but a case of delaying the video data can also be similarly described.

As described above, according to the present embodiment, the test content containing the determination video, with which the timing the determination audio is to be output can be visually judged, is reproduced, and thus the viewer can grasp the gap in timing, which the audio reproduction system has, between the display of the determination video and the output of the determination audio. The synchronization adjustment of the video and the audio can be performed easily and at high accuracy since the delay time of when distributing the video data and the audio data from the server 10 can be adjusted based on the gap in timing.

Since the delay time is adjusted in the server 10, the existing digital television and the audio system 12 can be used as is.

Furthermore, the display 11 may have only the video output function. That is, the display 11 may not have the audio content processing function and the demultiplexer function as with the digital television.

Furthermore, since the delay time can also be set in the audio coded data storage unit 22 and the video coded data storage unit 25 that handle data before decoding, the entire capacity of the audio coded data storage unit 22, the audio output data storage unit 24, the video coded data storage unit 25, and the video output data storage unit 27 can be reduced compared to when setting the delay time only in the audio output data storage unit 24 and the video output data storage unit 27 that handle data after decoding.

In the present embodiment, the delay time may also be adjustable in at least one of the display 11 and the audio system 12 in addition to the adjustment of the delay time in the server 10.

In this case, if the existing display 11 and the audio system 12 have the delay time adjustment function, synchronization adjustment can be performed without any modification to the existing devices. Moreover, since the delay time can also be adjusted in the server 10, the delay time to be set in the display 11 and the audio system 12 may be short. That is, the delay buffer required in the display 11 and the audio system 12 may have a small size.

Furthermore, in the present embodiment, the delay time may be adjusted in at least one of the server 10 or the audio system 12. That is, a configuration in which the delay time cannot be adjusted in the server 10, and the delay time can be adjusted only in the audio system 12 or in the audio system 12 and the display 11 may be adopted. In this case as well, if the existing display 11 and the audio system 12 has a delay time adjustment function, synchronization adjustment can be performed without any modification to the existing devices.

### Second Embodiment

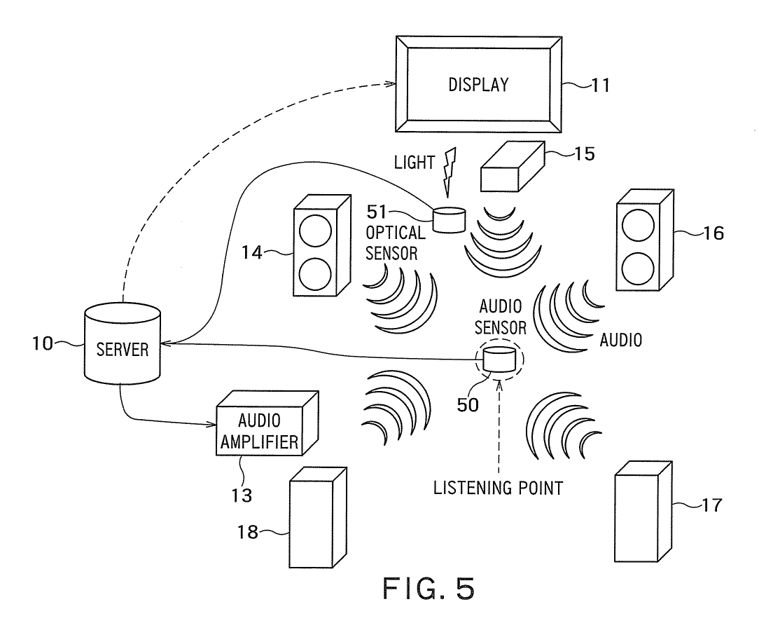

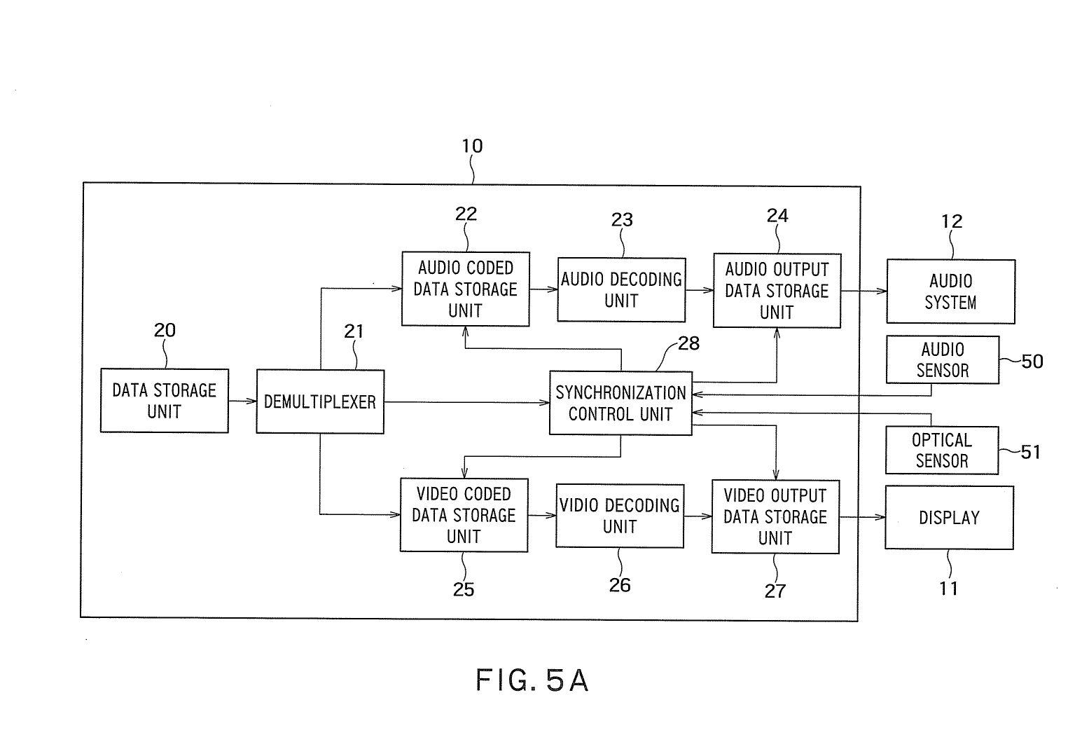

A second embodiment of the present invention will now be described with reference to FIGS. 5 to 7. The present embodiment differs from the first embodiment in that the determination audio and the determination video of the test content are detected using an audio sensor 50 and an optical sensor 51, and the server 10 adjusts the delay time of the video data and the audio data so that the difference between the time the determination video is detected and the time the determination audio is detected becomes short.

As shown in FIG. 5, the video and audio reproduction system according to the present embodiment includes the audio sensor 50 and the optical sensor 51 connected to the server 10. Other configurations are the same as the first embodiment, and thus detailed description will not be repeated.

The determination video of the test content involves brightness change at a timing the determination audio is to be output, as described in the first embodiment.

As shown in FIG. 5A, in the server 10 according to the present embodiment, the signals from the audio sensor 50 and the optical sensor 51 are input to the synchronization control unit 28. Other configurations are the same as the first embodiment, and thus detailed description will not be repeated.

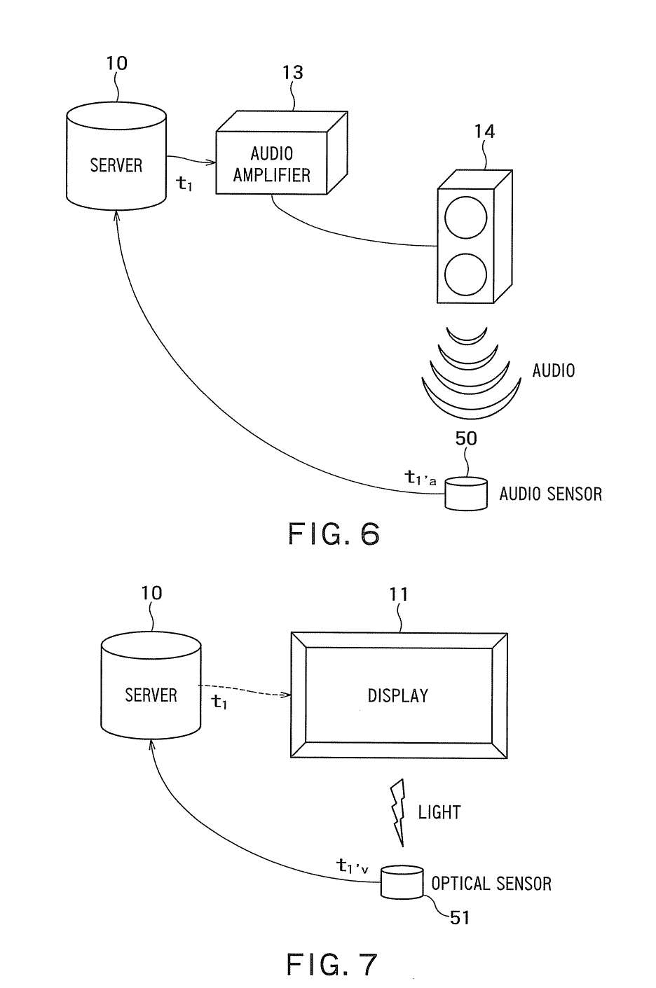

The calculation method of the audio delay time will be described with reference to FIG. 6. Assume the time the audio data of the determination audio is distributed from the server 10 to the audio system 12 is t₁, and the time the audio sensor 50 detects the determination audio output from the speakers 14 to 18 is t_{1′a}. The synchronization control unit 28 of the server 10 calculates t_{1′a}−t₁ to obtain the audio delay time t_{1ad}.

The calculation method of the video delay time will be described with reference to FIG. 7. Assume the time the video data of the determination video is distributed from the server 10 to the display 11 is t₁, and the time the optical sensor 51 detects the brightness change of the determination video to be displayed on the display 11 is t_{1′v}. The synchronization control unit 28 of the server 10 calculates t_{1′v}−t₁ to obtain the video delay time t_{1vd}.

The synchronization control unit 28 of the server 10 calculates a difference delay time t_{1d} of the audio delay time t_{1ad} and the video delay time t_{1vd}. The synchronization control unit 28 of the server 10 controls the delay time in the audio coded data storage unit 22 and the audio output data storage unit 24, or the video coded data storage unit 25 and the video output data storage unit 27 so that the difference delay time t_{1d} becomes short. The server 10 thereby adjusts the distribution timing of the video data and the audio data to the display 11 and the audio system 12.

For instance, if the audio delay time t_{1ad} is shorter than the video delay time t_{1vd}, the synchronization control unit 28 of the server 10 extends the delay time of the audio data by the difference delay time t_{1d} and delays the distribution timing.

If the audio delay time t_{1ad} is longer than the video delay time t_{1vd}, the synchronization control unit 28 of the server 10 extends the delay time of the video data by the difference delay time t_{1d} and delays the distribution timing.

The audio delay time t_{1ad} and the video delay time t_{1vd} thus become substantially equal, whereby the video and the audio to be delivered to the viewer can be synchronized.

As described above, according to the present embodiment, the determination video and the determination audio of the test content are detected by the audio sensor 50 and the optical sensor 51, and the server 10 adjusts the delay time of the video data and the audio data such that the difference between the time the determination video is detected and the time the determination audio is detected becomes short, so that the synchronization adjustment of the video and the audio can be automatically performed.

The server 10 may be configured to adjust the delay time in the display 11 and the audio system 12 based on the calculated delay time.

The embodiments of the present invention have been specifically described above, but the specific configurations are not limited to the above-described embodiments, and various modifications can be implemented within a scope not deviating from the subject matter of the present invention.

For instance, a case in which the server receives the digital broadcast has been described in the above embodiments, but the present invention can be applied to a case of receiving the IP broadcast and the like. The server merely need to be a device for distributing the video data and the audio data, and may be a DVD player and the like.

In the above-described embodiment, description has been made that the server delays the distribution of the video data and the audio data, but the distribution of at least the audio data may be delayed.

The server and the display may be wire connected. The server and the audio system may be wirelessly connected.

1. A distribution device comprising:
a video data distributing section which distributes video reproducing video data to an external video display device; and
an audio data distributing section which distributes audio reproducing audio data to an external audio output device,
wherein
the audio data distributing section comprises an audio distribution delay unit which delays the distribution of the audio data,
the distribution device is configured to be able to distribute the audio data of a determination audio and the video data of a determination video,
the determination video is a video with which a viewer can visually judge a timing the determination audio is to be output from the audio output device, and
the determination audio and the determination video are contained in synchronization adjustment test content.

2. The distribution device according to claim 1, wherein the video data distributing section comprises a video distribution delay unit which delays the distribution of the video data.

3. The distribution device according to claim 2, wherein the determination video involves brightness change at the timing.

4. The distribution device according to claim 3, further comprising:
an optical sensor;
an audio sensor; and
a synchronization control unit configured to calculate a video delay time and an audio delay time, and configured to control a delay time of the audio distribution delay unit or the video distribution delay unit so that a difference between the video delay time and the audio delay time becomes shorter, the video delay time being a difference between a time the video data of the determination video is distributed and a time the optical sensor detects the brightness change of the determination video, the audio delay time being a difference between a time the audio data of the determination audio is distributed and a time the audio sensor detects the determination audio.

5. The distribution device according to claim 2, further comprising:
a data storage unit which stores data; and
a demultiplexer which divides the data to audio coded data and video coded data, the video coded data and the audio coded data containing time information,
wherein
the audio data distributing section further comprises:
an audio coded data storage unit which stores and outputs the audio coded data;
an audio decoding unit which decodes the audio coded data output from the audio coded data storage unit, and generates the audio data; and
an audio output data storage unit which stores the audio data and outputs the audio data to the audio output device,
the audio distribution delay unit in the audio data distributing section comprising the audio coded data storage unit and the audio output data storage unit,
the video data distributing section further comprises:
a video coded data storage unit which stores and outputs the video coded data;
a video decoding unit which decodes the video coded data output from the video coded data storage unit, and generates the video data; and
a video output data storage unit which stores the video data and outputs the video data to the video display device,
the video distribution delay unit in the video data distributing section comprising the video coded data storage unit and the video output data storage unit, and
the distribution device further comprises a synchronization control unit which controls an output timing the video data and the audio data are output based on the time information and sets a delay time to at least one of the audio coded data storage unit, the audio output data storage unit, the video coded data storage unit, and the video output data storage unit.

6. The distribution device according to claim 5,
wherein the data stored in the data storage unit contains data of the test content,
a data format of the test content is TS (Transport Stream) packet configuration, and
a TS packet of the determination video and a TS packet of the determination audio at the timing contain the same time information.

7. The distribution device according to claim 1, wherein the determination video has a symbol displayed at a predetermined position at the timing.

8. A video and audio reproduction system comprising:
a distribution device which comprises a video data distributing section and an audio data distributing section, the video data distributing section distributing video reproducing video data, the audio data distributing section distributing audio reproducing audio data;
a video display device which processes the distributed video data and displays the video data as a video; and
an audio output device which processes the distributed audio data and outputs the audio data as an audio,
wherein
the distribution device is configured to be able to distribute the audio data of a determination audio and the video data of a determination video,
the determination video is a video with which a viewer can visually judge a timing the determination audio is to be output from the audio output device,
the determination audio and the determination video are contained in synchronization adjustment test content, and
at least either the distribution device or the audio output device is configured to delay the output of the audio from the audio output device so that the determination audio is output at the timing in the determination video.

9. The video and audio reproduction system according to claim 8, wherein the audio data distributing section in the distribution device comprises an audio distribution delay unit which delays the distribution of the audio data.

10. The video and audio reproduction system according to claim 9, wherein the video data distributing section in the distribution device comprises a video distribution delay unit which delays the distribution of the video data so that the determination audio is output at the timing in the determination video.

11. The video and audio reproduction system according to claim 10, wherein the determination video involves brightness change at the timing.

12. The video and audio reproduction system according to claim 11, wherein the distribution device further comprises:
an optical sensor;
an audio sensor; and
a synchronization control unit configured to calculate a video delay time and an audio delay time, and configured to control a delay time of the audio distribution delay unit or the video distribution delay unit so that a difference between the video delay time and the audio delay time becomes shorter, the video delay time being a difference between a time the video data of the determination video is distributed and a time the optical sensor detects the brightness change of the determination video, the audio delay time being a difference between a time the audio data of the determination audio is distributed and a time the audio sensor detects the determination audio.

13. The video and audio reproduction system according to claim 10, wherein the distribution device further comprises:
a data storage unit which stores data; and
a demultiplexer which divides the data to audio coded data and video coded data, the video coded data and the audio coded data containing time information,
the audio data distributing section further comprises:
an audio coded data storage unit which stores and outputs the audio coded data;
an audio decoding unit which decodes the audio coded data output from the audio coded data storage unit, and generates the audio data; and
an audio output data storage unit which stores the audio data and outputs the audio data to the audio output device,
the audio distribution delay unit in the audio data distributing section comprising the audio coded data storage unit and the audio output data storage unit,
the video data distributing section further comprises:
a video coded data storage unit which stores and outputs the video coded data;
a video decoding unit which decodes the video coded data output from the video coded data storage unit, and generates the video data; and
a video output data storage unit which stores the video data and outputs the video data to the video display device,
the video distribution delay unit in the video data distributing section comprising the video coded data storage unit and the video output data storage unit, and
the distribution device, further comprises a synchronization control unit which controls an output timing the video data and the audio data are output based on the time information and sets a delay time to at least one of the audio coded data storage unit, the audio output data storage unit, the video coded data storage unit, and the video output data storage unit.

14. The video and audio reproduction system according to claim 13, wherein the data stored in the data storage unit contains data of the test content,
a data format of the test content is TS (Transport Stream) packet configuration, and
a TS packet of the determination video and a TS packet of the determination audio at the timing contain the same time information.

15. The video and audio reproduction system according to claim 8, wherein the video display device is configured to delay the display of the video so that the determination audio is output at the timing in the determination video.

16. The video and audio reproduction system according to claim 8, wherein the determination video has a symbol displayed at a predetermined position at the timing.

17. A synchronization adjustment method using a video and audio reproduction system comprising: a distribution device which comprises a video data distributing section and an audio data distributing section, the video data distributing section distributing video reproducing video data, the audio data distributing section distributing audio reproducing audio data; a video display device which processes the distributed video data and displays the video data as a video; and an audio output device which processes the distributed audio data and outputs the audio data as an audio,
the method comprising:
distributing the audio data of a determination audio and the video data of a determination video by the distribution device, the determination video being a video with which a viewer can visually judge a timing the determination audio is to be output from the audio output device, the determination audio and the determination video being contained in synchronization adjustment test content; and
delaying the output of the audio from the audio output device by an audio delay time by at least either the distribution device or the audio output device so that the determination audio is output at the timing in the determination video.

18. The synchronization adjustment method according to claim 17, further comprising delaying the display of the video to the video display device by at least either the distribution device or the video output device so that the determination audio is output at the timing in the determination video.

19. The synchronization adjustment method according to claim 17, wherein
audio coded data containing time information is subjected to an audio decoding process to be used for the audio data, and
the delay of the output of the audio from the audio output device by the distribution device comprises:
a process of delaying the audio decoding process of the audio coded data until a reference time becomes greater than or equal to a first time, the first time being a time obtained by adding a predetermined delay time to the time information; and
a process of delaying the output to the audio output device of the audio data generated in the audio decoding process until the reference time becomes greater than or equal to a second time, the second time being a time obtained by adding the audio delay time to the time information.
